(19) United States
(12) Patent Application Publication
(10) Pub. No.: US 2013/0100445 A1
(43) Pub. Date: Apr. 25, 2013

(54) METHOD FOR DATA ACQUISITION

(71) Applicant: ALSTOM Technology Ltd, Baden (CH)

(72) Inventor: Ken Yves Haffner, Baden (CH)

(73) Assignee: ALSTOM TECHNOLOGY LTD, Baden (CH)

(21) Appl. No.: 13/656,363

(22) Filed: Oct. 19, 2012

(30) Foreign Application Priority Data
Oct. 24, 2011 (EP) 11186292.6

(51) Int. Cl. G01J 3/42

(52) U.S. Cl. 356/338

(57) ABSTRACT

A method for data acquisition from a combustion process that generates hot gases includes directing a light beam through the hot gases, detecting signals indicative of a scattered beam in a predefined direction by each hot gas volume through which the light beam passes through, processing the detected signals to ascertain the absorption spectrum of the hot gases, processing the absorption spectrum to obtain data indicative of the combustion process.

### INCORPORATION BY REFERENCE

The following document is incorporated herein by reference as if fully set forth: European patent application no. 11186292.6, filed Oct. 24, 2011.

### FIELD OF INVENTION

The present invention relates to a method for data acquisition. In particular, the method is useful to ascertain data indicative of the combustion process that occurs is a combustion chamber of a gas turbine.

### BACKGROUND

During development and operation of gas turbines, a number of data indicative of the combustion process occurring in the combustion chambers must be collected. For example data include temperature and other data such as pressure, composition, etc.

Usually, temperatures are collected using a thermocouple array that is introduced into the combustion chamber (close to its outlet).

These thermocouple arrays do not guarantee precise measurements, because of the limited number of thermocouples that can practically be provided and of the disturbance to the flow caused by their presence.

In addition, these thermocouple arrays only allow temperature measurements to be carried out. Further, in order to get measurements of other relevant data, additional appropriate sensors must be provided.

US 2008/0289342 discloses a method for monitoring and controlling a combustion process. According to the method, a laser beam is transmitted from the outer casing of a combustion chamber and is reflected back from the inner casing thereof; this reflected beam is thus detected and processed.

According to this method, cumulative data relating to the whole path between the inner and outer casing can be detected, but no data regarding specific volumes (i.e. specific volumes between the inner and outer casing) can be obtained.

### SUMMARY

The present disclosure is directed to a method for data acquisition from a combustion process that generates hot gases. The method includes directing a light beam through the hot gases; detecting signals indicative of scattered beams in a predefined direction having an angle greater than 0° relative to a direction of the light beam for each hot gas volume through which the light beam passes through. The method also includes processing the detected signals, ascertaining the absorption spectrum of the hot gases; and processing the absorption spectrum to obtain data indicative of the combustion process.

### BRIEF DESCRIPTION OF THE DRAWINGS

Further characteristics and advantages will be more apparent from the description of a preferred but non-exclusive embodiment of the method, illustrated by way of non-limiting example in the drawings, in which:

FIG. 1 is a schematic view of a device connected to a gas turbine combustion chamber;

FIG. 2 shows a detail of scattered beams directed toward a collimating lens;

FIGS. 3 and 4 show different detector schemes;

FIG. 5 shows the wavelength (λ)—time relationship of one component forming the laser beam;

FIG. 6 shows the wavelength (λ)—time relationship of one component of the scattered beam deriving from the laser beam of FIG. 5;

FIG. 7 shows the absorption (wavelength (λ)—time relationship) of the medium (hot gases) through which the laser component of FIG. 5 passes through;

FIG. 8 shows the wavelength (λ)—time relationship of components forming the laser beam;

FIG. 9 shows an example of a laser source; and

FIG. 10 shows a detail of a laser beam.

### DETAILED DESCRIPTION OF THE PREFERRED EMBODIMENTS

### Introduction to the Embodiments

An aspect of the disclosure includes providing a method by which measurements at specific volumes can be carried out.

Another aspect of the disclosure includes providing a method by which precise measurements can be carried out to obtain, for example, the temperature profile at the combustion chamber exit.

Another aspect of the disclosure is to provide a method that permits measurement of a number of different data (i.e. not only the temperature); for example these additional data include pressure, concentration and composition.

These and further aspects are attained by providing a method in accordance with the accompanying claims.

### DETAILED DESCRIPTION

In the following a device for data acquisition is described first.

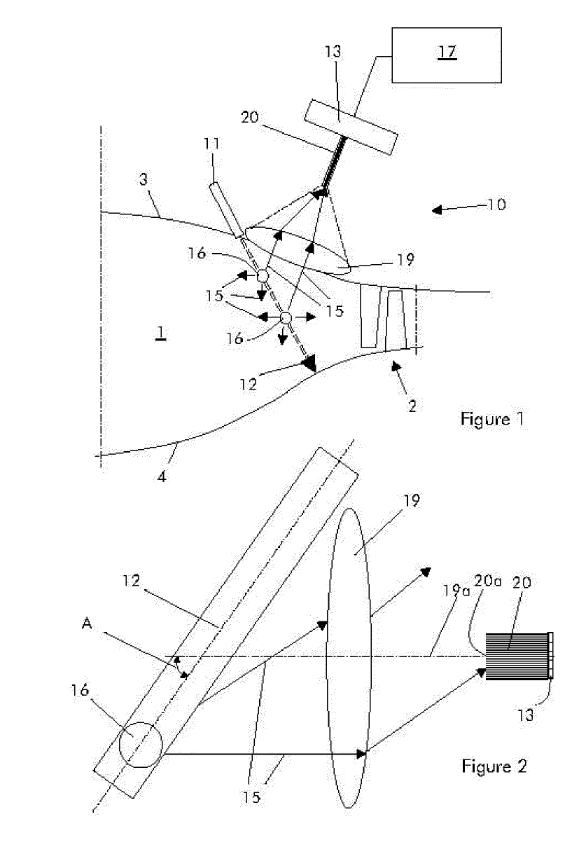

FIG. 1 shows a combustion chamber 1 of a gas turbine and a high pressure turbine stage 2 downstream of it. In the combustion chamber 1 air and fuel are injected and combusted generating hot gases that are directed to the turbine stage 2.

The combustion chamber 1 has an outer casing 3 and an inner casing 4; the device 10 is preferably connected to the outer casing 3, however, it can also be connected to the inner casing 4.

The device 10 comprises a light beam source 11 (such as a laser source) for directing a light beam 12 through the hot gases generated during the combustion. The wavelength of the light beam source 11 is preferably tunable.

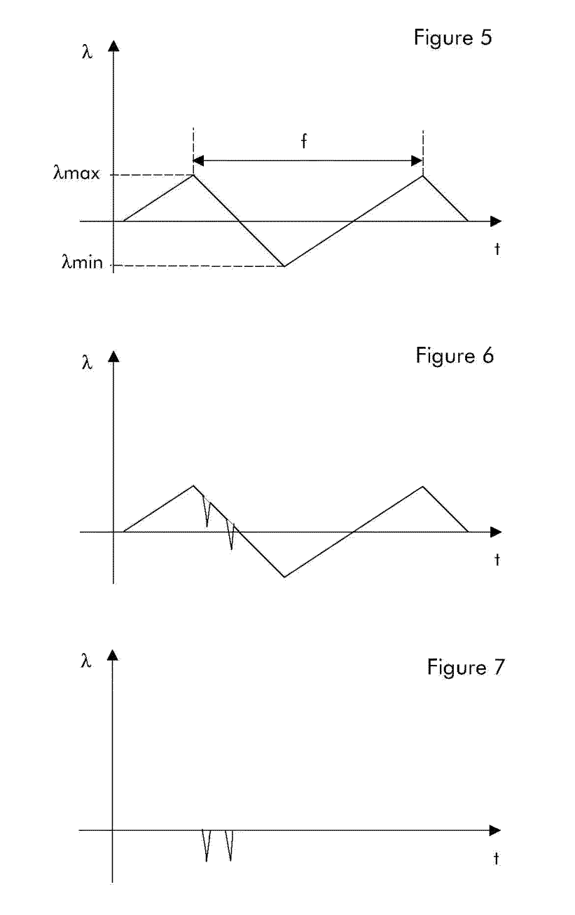

For example the light beam source 11 can include a plurality of laser diodes 11a-d each generating a laser beam 12a at a given frequency (FIG. 9). Each laser diode operates at a predefined frequency and is tunable between a minimum and a maximum wavelength. In this respect, FIG. 5 shows an example of the radiation emitted by one laser diode that operates at a given frequency f and is tunable between the wavelengths λmax and λmin.

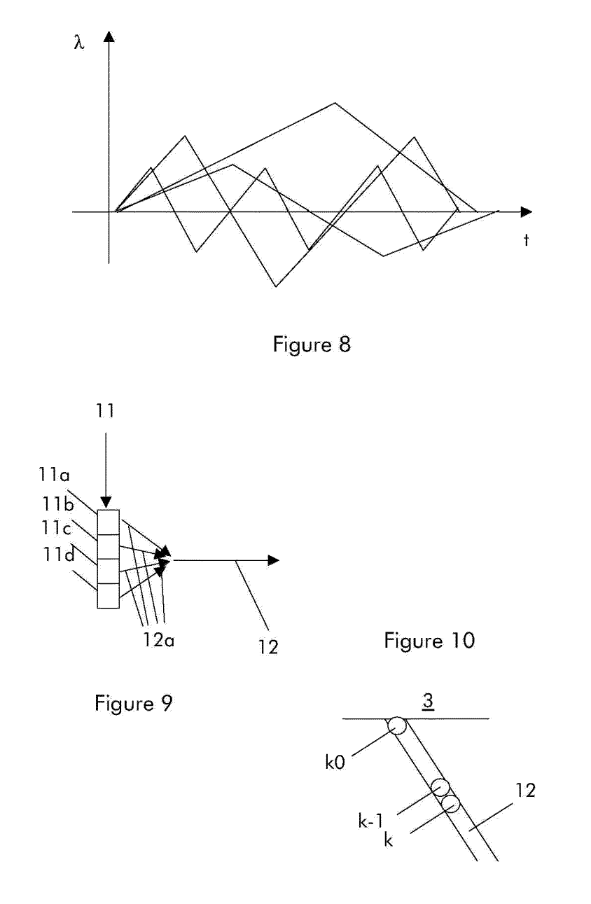

The laser beams 12a generated by each laser diode 11a-d are mixed together to generate the laser beam 12 that is directed into the combustion chamber 1. In this respect FIG. 8 shows an example of the radiation emitted by a plurality of tunable laser diodes 11a-d each operating at a given frequency.

Naturally instead of laser diodes any other kind of laser source can be used.

The device 10 also includes one or more detectors 13 of signals indicative of a scattered beam 15 emitted in a predefined direction by each hot gas volume 16 through which the light beam 12 passes through.

The device 10 also includes a process unit 17 for processing the detected signals, to get the absorption spectrum of the hot gases. The process unit can be a computer and preferably operates according to the heterodyne method.

Advantageously, a collimating lens 19 for selecting the direction of the scattered beam 15 is provided; the collimating lens 19 faces a window in the outer casing 3 and provides the optic signal to the detectors 13; preferably the collimating lens 19 consists of one aspheric lens.

In addition, optic fibers 20 (for example multimode optic fibers) can be provided between the collimating lens 19 and the detector 13 (anyhow this feature is not needed).

FIG. 4 shows an example, in which the optic fibers 20 are connected to an array of detectors 13.

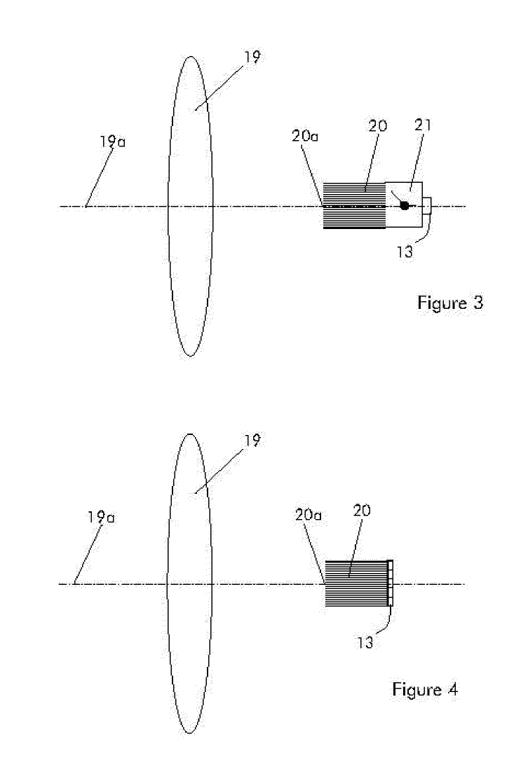

FIG. 3 shows another example in which the optic fibers 20 are connected to an optic switch 21 (such as a MEMS device (micro electro mechanical systems) or electro optical modulators or other devices) and thus to one detector 13.

Naturally the schemes of FIGS. 3 and 4 can be used in the same device according to the needs.

Advantageously, when the collimating lens 19 and the optic fibers 20 are both provided, the ends 20a of the optic fibers are located at the focal point of the lens 19. In contrast, when the collimating lens 19 is provided (but the optic fibers 20 are not provided), the detector(s) 13 or the optic switch 21 is located at the focal point of the lens 19.

The operation of the device is substantially the following.

The laser source 11 generates the laser beam 12 (whose features are for example shown in FIG. 8) that passes through the combustion chamber 1 and the hot gases flowing through it. The laser source 11 is continuously tuned, such that each frequency of the laser beam 12 continuously changes between a given wavelength range (FIG. 5 shows a single component at a given frequency of the laser beam 12).

When the laser beam 12 passes through each volume 16, it is partly adsorbed by the substances contained in the volume 16 (FIG. 6 shows the absorption for the component of FIG. 9).

Then each volume 16 reemits scattered beams 15 in all directions; thus a part of the scattered beams 15 directs toward the lens 19.

When the scattered beams 15 reach the lens 19, only those beams propagating in a direction parallel to the optical axis 19a of the lens 19 pass through the lens 19, enter the optic fibers 20 and reach the detector 13. The scattered beams 15 not propagating in the direction parallel to the optical axis 19a are not focused on the focus point of the lens 19 where converge the ends 20a of the optic fibers 20 or where the optic switch 21 or detector(s) 13 are located; for this reason they are not detected. Since only scattered beams 15 propagating in a given direction are detected, specific local information can be detected and the temperature profile (or other features) can be reconstructed.

In the embodiment of FIG. 4 the signals indicative of a scattered beam 15 continuously reach each of the detectors 13 whereas in the embodiment of FIG. 3 one signal at a time reaches the detector 13.

These signals indicative of a scattered beam 15 are converted into electric signals at the detector(s) 13; these electric signals are thus provided to the process unit 17, that elaborates them (preferably according to the heterodyne method) to separate the frequency component from one another and to reconstruct the absorption spectrum of the hot gases for each volume 16 facing each detector 13 or optic fiber.

Since the wavelength of the laser beam 12 that was emitted is known, it is possible to ascertain the absorption at each frequency and thus it is possible to ascertain the features of the hot gases. FIG. 7 shows the absorption of the hot gas at the frequency of the laser component of FIG. 5.

In the following, the method for data acquisition from a combustion process that generates hot gases is described.

The method comprises directing a light beam 12 through the hot gases. Preferably the light beam 12 is a laser beam having one or more components at different frequencies that are preferably tuned between a minimum and a maximum wavelength; these minimum and maximum wavelength can be chosen according to the components of the flue gases that must be detected (for example CO, CO2, NO, NO2, etc).

The method comprises detecting signals indicative of a scattered beam 15 in a predefined direction having an angle greater than 0° relative to the direction of the light beam (12) for each hot gas volume 16 through which the light beam 12 passes through, and processing the detected signals to get the hot gas absorption spectrum.

The absorption spectrum is thus processed to obtain data indicative of the combustion process, such as temperature and/or pressure and/or composition and/or concentration of selected gas components or also different features. This elaboration is well known in the art (tunable diode laser absorption spectroscopy, TDLAS).

The light beam 12 is emitted at a predefined angle A with respect to the optical axis of the lens 19; preferably the predefined angle A is smaller than 40 degree, larger than 0 degree, and more preferably between 15-25 degrees. This permits a compact arrangement to be obtained; it is however clear that different angles are also possible.

Preferably, during detection, scattered beams 15 from volumes 16 closer and farther from the detector 13 are detected. During processing data indicative of the combustion process from volumes 16 farther from the light source 11 are calculated on the basis of the data indicative of the combustion process from volumes 16 closer to the light source 11.

In other words, since the laser beam 12 passing through a relevant volume 16 is already partially attenuated (because of the volumes 16 through which it has already passed through), the signal derived from it is indicative of the average of the conditions at the relevant volume 16 and also at all of the other volumes 16 through which the laser beam 12 has already passed through. The actual conditions at the relevant volume k can thus be calculated (naturally the light beam 12 from the first volume adjacent to the casing has no previous absorption and needs no calculation).

For example (FIG. 10), at a volume k−1 a temperature of T=1830 K was calculated and at a volume k a temperature T=1820 K is measured, the actual temperature at the volume k is:

1820*2−1830=1810 K.

If at a volume k0 adjacent to the casing that carries the laser source 11 a temperature of 1830 K is measured; this is the actual temperature at this volume.

According to one embodiment the hot gas volume through which the light beam 12 passes can be virtually divided into discrete hot gas volumes 16 in the direction of the light beam 12. Each discrete hot gas volume 16 can be correlated to a section of the collimating lens 19 and/or to an optical fiber 20 leading to the sensor 13.

This way, different data such as the temperature, pressure compositions can be ascertained. In addition, since the data refer to selected volumes within the combustion chamber, also very specific information such as the temperature profile can be ascertained.

For example, in order to ascertain the concentration of a selected gas component, a molecule absorption spectrum for selected molecules can be provided and elaborating the absorption spectrum to get data indicative of the concentration comprises comparing the absorption spectrum to the molecule absorption spectrum.

Naturally the features described may be independently provided from one another.

In practice the materials used and the dimensions can be chosen at will according to requirements and to the state of the art.

It is understood, therefore, that this invention is not limited to the particular embodiments disclosed, but is intended to cover all modifications which are within the spirit and scope of the invention as defined by the appended claims; the above description; and/or shown in the attached drawings.

### REFERENCE NUMBERS

1 combustion chamber
2 turbine stage
3 outer casing
4 inner casing
10 device
11, 11a-d light source
12, 12a light beam
13 detector
15 scattered beam
16 volume
17 process unit
19 collimating lens
19a optical axis
20 optic fibers
20a end of optic fibers
21 optic switch
f frequency
k, k0, k−1 volumes at different positions
t time
A angle
λ, λmax, λmin wavelength

What is claimed is:

1. A method for data acquisition from a combustion process that generates hot gases, the method comprising:
directing a light beam through the hot gases,
detecting signals indicative of scattered beams in a predefined direction having an angle greater than 0° relative to a direction of the light beam for each hot gas volume through which the light beam passes through,
processing the detected signals, ascertaining the absorption spectrum of the hot gases,
processing the absorption spectrum to obtain data indicative of the combustion process.

2. The method according to claim 1, further comprising selecting the predefined direction of the scattered beam by a lens having an optical axis, wherein the light beam is emitted at a predefined angle with respect to the optical axis of the lens, the predefined angle being between 0-40 degrees.

3. The method according to claim 1, further comprising selecting the predefined direction of the scattered beam by a lens having an optical axis, wherein the light beam is emitted at a predefined angle with respect to the optical axis of the lens, the predefined angle being between 15-25 degrees.

4. The method according to claim 1, wherein detection is carried out via at least one detector, during detection, beams scattered from volumes close to and farther away from the at least one detector are detected, wherein during processing data indicative of the combustion process from volumes farther from at least one light source are calculated on the basis of the data indicative of the combustion process from volumes closer to the at least one light source.

5. The method according to claim 1, wherein the data indicative of the combustion process includes at least one of temperature, pressure, concentration or composition.

6. The method according to claim 5, further comprising providing a molecule absorption spectrum for selected molecules, wherein processing a detected absorption spectrum to ascertain data indicative of a concentration of a selected gas component comprises comparing the detected absorption spectrum to the molecule absorption spectrum.

7. The method according to claim 1, wherein the light beam has at least one component at a given frequency that is continuously tuned between a minimum and a maximum wavelength.

8. The method according to claim 1, wherein the light beam includes a plurality of components each having a given frequency.

9. The method according to claim 1, wherein the light beam is a laser beam.

10. The method according to claim 1, wherein the combustion occurs in a gas turbine combustion chamber.
